(19) United States
(12) Patent Application Publication
(10) Pub. No.: US 2023/0245087 A1
(43) Pub. Date: Aug. 3, 2023

(54) META-WORLD AUTONOMOUS STORE

(71) Applicant: AiFi Corp, Santa Clara, CA (US)

(72) Inventor: Steve Gu, Santa Clara, CA (US)

(73) Assignee: AiFi Corp, Santa Clara, CA (US)

(21) Appl. No.: 17/591,603

(22) Filed: Feb. 3, 2022

(51) Int. Cl. G06Q 20/18; G06Q 20/20; G06Q 20/32; G06V 20/20

(52) U.S. Cl. CPC G06Q 20/18; G06Q 20/208; G06Q 20/3276; G06Q 20/3224; G06V 20/20

(57) ABSTRACT

This application relates to systems, methods, devices, and other techniques for a meta world autonomous store that can be utilized within a retail environment.

### BACKGROUND OF THE INVENTION

This application relates to systems, methods, devices, and other techniques for a smart autonomous store system that can be utilized within a retail environment.

Methods and apparatus for using cameras in a retail store for monitoring products and customers are well known and in practices. However, systems, methods, devices, and other techniques for a system for a smart autonomous store that can be utilized within a retail environment need is new and could be combined with recently developed AI and machine learning and sensor technology.

Therefore, it is desirable to have systems, methods, devices, and other techniques for a smart autonomous store that can be utilized within a retail environment.

### SUMMARY OF THE INVENTION

This application relates to systems, methods, devices, and other techniques for a smart autonomous store entry system that can be utilized within a retail environment.

This system with doors, cameras, and sensors is designed to have many functions within a store with identification system and sometimes can be utilized in a store with or without human cashier.

In some embodiments, the invention is related a meta-world autonomous store, comprises: an entry point coupled to the meta-world autonomous store, wherein the entry point is configured to enable customers to enter the meta-world autonomous store without delay without hinderance of a gate or door; a display coupled to the meta-world autonomous store, wherein the display is configured to be viewable to persons outside of the meta-world autonomous store, wherein the display is configured to display promotional information, wherein the display is configured to display a phrase of “welcome”; at least one shelf coupled to the meta-world autonomous store, wherein items are displayed on the at least one shelf; a set of cameras coupled to the meta-world autonomous store, wherein the set of cameras is configured to capture video information of the items on the at least one shelf, wherein the set of cameras is configured to track any shopper and shows meta-world type of visual avatars of the any shopper in a screen coupled to the set of cameras, wherein movements and items picked up and carried by the meta-world type of visual avatars of the any shopper are tracked in the screen coupled to the set of cameras, wherein key points of the any shoppers are tracked and shown in the screen with amination of picking up or put back items; a cloud based server coupled to the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the at least one shelf, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device; an unattended checkout device coupled to the cloud based server, wherein the unattended checkout device is configured to show the item in a list carried by a shopper when the shopper is within a geo-fenced area near the unattended checkout device, wherein the shopper can add or delete items from the list, wherein the unattended checkout device is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store; and an exit gate with an alarm system coupled to the cloud based server, wherein the alarm system is configured to send alarm signals if a person exits without legal payment.

In some embodiments, the invention is related to a meta-world autonomous store, comprises: an entry point coupled to the meta-world autonomous store, wherein the entry point is configured to enable customers to enter the meta-world autonomous store without delay without hinderance of a gate or door; a display coupled to the meta-world autonomous store, wherein the display is configured to be viewable to persons outside of the meta-world autonomous store, wherein the display is configured to display promotional information, wherein the display is configured to display a phrase of “welcome”; at least one shelf coupled to the meta-world autonomous store, wherein items are displayed on the at least one shelf; a set of cameras coupled to the meta-world autonomous store, wherein the set of cameras is configured to capture video information of the items on the at least one shelf, wherein the set of cameras is configured to track any shopper and shows meta-world type of visual avatars of the any shopper in a screen coupled to the set of cameras, wherein movements and items picked up and carried by the meta-world type of visual avatars of the any shopper are tracked in the screen coupled to the set of cameras, wherein key points of the any shoppers are tracked and shown in the screen with amination of picking up or put back items; a cloud based server coupled to the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the at least one shelf, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device; and an unattended checkout device coupled to the cloud based server, wherein the unattended checkout device is configured to show the item in a list carried by a shopper when the shopper is within a geo-fenced area near the unattended checkout device, wherein the shopper can add or delete items from the list, wherein the unattended checkout device is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.

In some embodiments, the invention is related to a meta-world autonomous store, comprises: an entry point coupled to the meta-world autonomous store, wherein the entry point is configured to enable customers to enter the meta-world autonomous store without delay without hinderance of a gate or door; at least one shelf coupled to the meta-world autonomous store, wherein items are displayed on the at least one shelf; a set of cameras coupled to the meta-world autonomous store, wherein the set of cameras is configured to capture video information of the items on the at least one shelf, wherein the set of cameras is configured to track any shopper and shows meta-world type of visual avatars of the any shopper in a screen coupled to the set of cameras, wherein movements and items picked up and carried by the meta-world type of visual avatars of the any shopper are tracked in the screen coupled to the set of cameras, wherein key points of the any shoppers are tracked and shown in the screen with amination of picking up or put back items; a cloud based server coupled to the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the at least one shelf, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device; and an unattended checkout device coupled to the cloud based server, wherein the unattended checkout device is configured to show the item in a list carried by a shopper when the shopper is within a geo-fenced area near the unattended checkout device, wherein the shopper can add or delete items from the list, wherein the unattended checkout device is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.

These and other aspects, their implementations and other features are described in details in the drawings, the description and the claims.

### BRIEF DESCRIPTION OF THE DRAWINGS

FIG. 1 shows an example of a meta world smart store.

FIG. 2 shows another example of a meta world smart store.

FIG. 3 shows a third example of a meta world smart store.

### DETAILED DESCRIPTION OF THE INVENTION

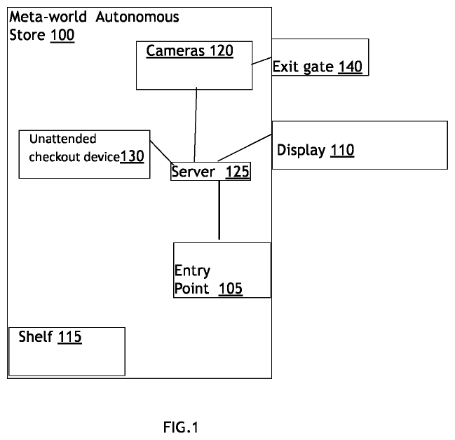

FIG. 1 shows an example of a meta world smart store 100.

In some implementations, A meta-world autonomous store 100, comprises: an entry point 105 coupled to the meta-world autonomous store 100, wherein the entry point 105 is configured to enable customers to enter the meta-world autonomous store 100 without delay without hinderance of a gate or door.

In some embodiments, the meta-world autonomous store 100, comprises a display 110 coupled to the meta-world autonomous store 100, wherein the display 110 is configured to be viewable to persons outside of the meta-world autonomous store 100, wherein the display 110 is configured to display promotional information, wherein the display is configured to display a phrase of “welcome”;

In some embodiments, the meta-world autonomous store 100, comprises at least one shelf 115 coupled to the meta-world autonomous store 100, wherein items are displayed on the at least one shelf;

In some embodiments, the meta-world autonomous store 100, comprises a set of cameras 120 coupled to the meta-world autonomous store 100, wherein the set of cameras 120 is configured to capture video information of the items on the at least one shelf 115, wherein the set of cameras 120 is configured to track any shopper and shows meta-world type of visual avatars of the any shopper in a screen coupled to the set of cameras 120, wherein movements and items picked up and carried by the meta-world type of visual avatars of the any shopper are tracked in the screen coupled to the set of cameras, wherein key points of the any shoppers are tracked and shown in the screen with amination of picking up or put back items;

In some embodiments, the meta-world autonomous store 100, comprises a cloud based server 125 coupled to the set of cameras via internet connections, wherein the cloud based server 125 is configured to use computational resources to process the video information from the set of cameras, wherein the cloud based server is configured to prioritize computational resources to any cameras of the set of cameras with a view of the location of the each item coupled to any of the at least one shelf 115, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device.

In some embodiments, the meta-world autonomous store 100, comprises an unattended checkout device 130 coupled to the cloud based server 125, wherein the unattended checkout device 130 is configured to show the item in a list carried by a shopper when the shopper is within a geo-fenced area near the unattended checkout device, wherein the shopper can add or delete items from the list, wherein the unattended checkout device 130 is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.

In some embodiments, the meta-world autonomous store 100, comprises an exit gate 140 with an alarm system coupled to the cloud based server 125, wherein the alarm system is configured to send alarm signals if a person exits without legal payment.

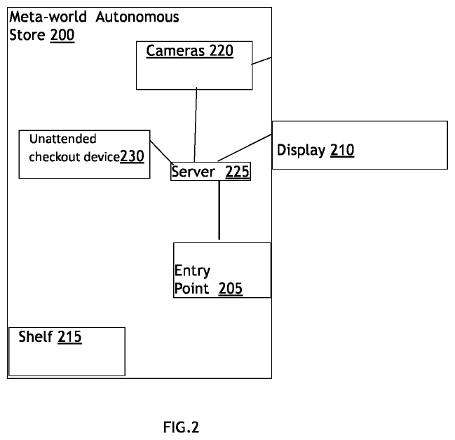

FIG. 2 shows an example of a meta world smart store 200.

In some implementations, a meta-world autonomous store 200, comprises: an entry point 105 coupled to the meta-world autonomous store 200, wherein the entry point 205 is configured to enable customers to enter the meta-world autonomous store 200 without delay without hinderance of a gate or door.

In some embodiments, the meta-world autonomous store 200, comprises a display 210 coupled to the meta-world autonomous store 200, wherein the display 210 is configured to be viewable to persons outside of the meta-world autonomous store 200, wherein the display 210 is configured to display promotional information, wherein the display is configured to display a phrase of “welcome”.

In some embodiments, the meta-world autonomous store 200, comprises at least one shelf 215 coupled to the meta-world autonomous store 200, wherein items are displayed on the at least one shelf.

In some embodiments, the meta-world autonomous store 200, comprises a set of cameras 220 coupled to the meta-world autonomous store 200, wherein the set of cameras 220 is configured to capture video information of the items on the at least one shelf 215, wherein the set of cameras 220 is configured to track any shopper and shows meta-world type of visual avatars of the any shopper in a screen coupled to the set of cameras 220, wherein movements and items picked up and carried by the meta-world type of visual avatars of the any shopper are tracked in the screen coupled to the set of cameras, wherein key points of the any shoppers are tracked and shown in the screen with amination of picking up or put back items.

In some embodiments, the meta-world autonomous store 200, comprises a cloud based server 225 coupled to the set of cameras via internet connections, wherein the cloud based server 225 is configured to use computational resources to process the video information from the set of cameras, wherein the cloud based server is configured to prioritize computational resources to any cameras of the set of cameras with a view of the location of the each item coupled to any of the at least one shelf 215, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device.

In some embodiments, the meta-world autonomous store 200, comprises an unattended checkout device 230 coupled to the cloud based server 225, wherein the unattended checkout device 230 is configured to show the item in a list carried by a shopper when the shopper is within a geo-fenced area near the unattended checkout device, wherein the shopper can add or delete items from the list, wherein the unattended checkout device 230 is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.

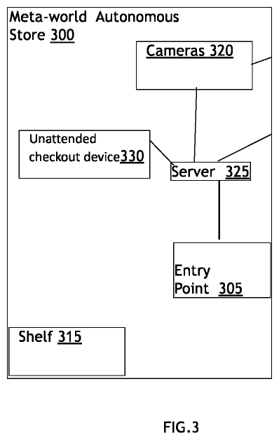

FIG. 3 shows an example of a meta world smart store 300.

In some implementations, A meta-world autonomous store 300, comprises: an entry point 305 coupled to the meta-world autonomous store 300, wherein the entry point 305 is configured to enable customers to enter the meta-world autonomous store 300 without delay without hinderance of a gate or door.

In some embodiments, the meta-world autonomous store 300, comprises at least one shelf 315 coupled to the meta-world autonomous store 300, wherein items are displayed on the at least one shelf;

In some embodiments, the meta-world autonomous store 300, comprises a set of cameras 320 coupled to the meta-world autonomous store 300, wherein the set of cameras 320 is configured to capture video information of the items on the at least one shelf 315, wherein the set of cameras 320 is configured to track any shopper and shows meta-world type of visual avatars of the any shopper in a screen coupled to the set of cameras 320, wherein movements and items picked up and carried by the meta-world type of visual avatars of the any shopper are tracked in the screen coupled to the set of cameras, wherein key points of the any shoppers are tracked and shown in the screen with amination of picking up or put back items;

In some embodiments, the meta-world autonomous store 300, comprises a cloud based server 325 coupled to the set of cameras via internet connections, wherein the cloud based server 325 is configured to use computational resources to process the video information from the set of cameras, wherein the cloud based server is configured to prioritize computational resources to any cameras of the set of cameras with a view of the location of the each item coupled to any of the at least one shelf 315, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device;

In some embodiments, the meta-world autonomous store 300, comprises an unattended checkout device 330 coupled to the cloud based server 325, wherein the unattended checkout device 330 is configured to show the item in a list carried by a shopper when the shopper is within a geo-fenced area near the unattended checkout device, wherein the shopper can add or delete items from the list, wherein the unattended checkout device 330 is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.

1. A meta-world autonomous store, comprises:
an entry point coupled to the meta-world autonomous store, wherein the entry point is configured to enable customers to enter the meta-world autonomous store without delay without hinderance of a gate or door;
a display coupled to the meta-world autonomous store, wherein the display is configured to be viewable to persons outside of the meta-world autonomous store, wherein the display is configured to display promotional information, wherein the display is configured to display a phrase of “welcome”;
at least one shelf coupled to the meta-world autonomous store, wherein items are displayed on the at least one shelf;
a set of cameras coupled to the meta-world autonomous store, wherein the set of cameras is configured to capture video information of the items on the at least one shelf, wherein the set of cameras is configured to track any shopper and shows meta-world type of visual avatars of the any shopper in a screen coupled to the set of cameras, wherein movements and items picked up and carried by the meta-world type of visual avatars of the any shopper are tracked in the screen coupled to the set of cameras, wherein key points of the any shoppers are tracked and shown in the screen with amination of picking up or put back items;
a cloud based server coupled to the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the at least one shelf, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device;
an unattended checkout device coupled to the cloud based server, wherein the unattended checkout device is configured to show the item in a list carried by a shopper when the shopper is within a geo-fenced area near the unattended checkout device, wherein the shopper can add or delete items from the list, wherein the unattended checkout device is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store; and
an exit gate with an alarm system coupled to the cloud based server, wherein the alarm system is configured to send alarm signals if a person exits without legal payment.

2. A meta-world autonomous store, comprises:
an entry point coupled to the meta-world autonomous store, wherein the entry point is configured to enable customers to enter the meta-world autonomous store without delay without hinderance of a gate or door;
a display coupled to the meta-world autonomous store, wherein the display is configured to be viewable to persons outside of the meta-world autonomous store, wherein the display is configured to display promotional information, wherein the display is configured to display a phrase of “welcome”;
at least one shelf coupled to the meta-world autonomous store, wherein items are displayed on the at least one shelf;
a set of cameras coupled to the meta-world autonomous store, wherein the set of cameras is configured to capture video information of the items on the at least one shelf, wherein the set of cameras is configured to track any shopper and shows meta-world type of visual avatars of the any shopper in a screen coupled to the set of cameras, wherein movements and items picked up and carried by the meta-world type of visual avatars of the any shopper are tracked in the screen coupled to the set of cameras, wherein key points of the any shoppers are tracked and shown in the screen with amination of picking up or put back items;
a cloud based server coupled to the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the at least one shelf, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device; and
an unattended checkout device coupled to the cloud based server, wherein the unattended checkout device is configured to show the item in a list carried by a shopper when the shopper is within a geo-fenced area near the unattended checkout device, wherein the shopper can add or delete items from the list, wherein the unattended checkout device is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.

3. A meta-world autonomous store, comprises:
an entry point coupled to the meta-world autonomous store, wherein the entry point is configured to enable customers to enter the meta-world autonomous store without delay without hinderance of a gate or door;
at least one shelf coupled to the meta-world autonomous store, wherein items are displayed on the at least one shelf;
a set of cameras coupled to the meta-world autonomous store, wherein the set of cameras is configured to capture video information of the items on the at least one shelf, wherein the set of cameras is configured to track any shopper and shows meta-world type of visual avatars of the any shopper in a screen coupled to the set of cameras, wherein movements and items picked up and carried by the meta-world type of visual avatars of the any shopper are tracked in the screen coupled to the set of cameras, wherein key points of the any shoppers are tracked and shown in the screen with amination of picking up or put back items;
a cloud based server coupled to the set of cameras via internet connections, wherein the cloud based server is configured to use computational resources to process the video information from the set of cameras, wherein the cloud based server is configured to prioritize computational resources to any cameras of the set of cameras with a view of the location of the each item coupled to the at least one shelf, wherein the cloud based server is configured to compute total price of the item removed by a shopper of the any shopper and charge the shopper the total price of the items and count as an transaction, wherein the total price is charged to the shopper automatically after the shopper exits meta-world autonomous store, wherein a receipt of the total price is sent to the shopper ‘mobile device; and
an unattended checkout device coupled to the cloud based server, wherein the unattended checkout device is configured to show the item in a list carried by a shopper when the shopper is within a geo-fenced area near the unattended checkout device, wherein the shopper can add or delete items from the list, wherein the unattended checkout device is configured to complete transaction if the shopper chooses and send a paid message to the cloud based server and the shopper's mobile device when payment of the products is successful, wherein a QR code is generated for the transaction, wherein the transaction can be completed by credit card payment, application in the shopper's mobile device, a QR code app linked to a payment account, face or palm scan linked to another payment account, wherein the transaction can also be completed by a cash payment, wherein another display coupled to the unattended checkout device shows the total price of the transaction, wherein scanning the QR code leads the shopper to a customized website with purchased items, unique link customized to the shopper, specialized promotion based the shopper's trip in the meta-world autonomous store even if the shopper is not registered with the meta-world autonomous store.
